(19) United States
(12) Patent Application Publication
(10) Pub. No.: US 2020/0081335 A1
(43) Pub. Date: Mar. 12, 2020

(54) STATIONARY LIGHT SOURCE

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: SHI-KAI HUANG, New Taipei (TW)

(21) Appl. No.: 16/174,304

(22) Filed: Oct. 30, 2018

(30) Foreign Application Priority Data
Sep. 6, 2018 (CN) 201811037976.0

(51) Int. Cl. G03B 21/20

(52) U.S. Cl. CPC G03B 21/204; G03B 21/208; G03B 21/2066

(57) ABSTRACT

A stationary light source includes a light source group, a light guide assembly, and a light combining device. The light source group includes a laser source, a scattering mirror, and a fluorescent scattering mirror. A laser beam generated by the laser source includes two beams, a first beam shining onto the scattering mirror generating a first colored light, and a second beam shining onto the fluorescent scattering mirror generating a second colored light. The scattering mirror and the fluorescent scattering mirror are located within the light combining device. The light combining device is configured to combine and concentrate the first colored light and the second colored light and emit the combined and concentrated light onto the light guide assembly. The light combining device is a semielliptical hollow reflecting mirror.

### FIELD

The subject matter herein generally relates to light sources, and more particularly to a stationary light source for use in a projector.

### BACKGROUND

Laser projectors are becoming commonly used for their high contrast, high brightness, and high color saturation. Generally, Laser projectors have a complicated structure.

### BRIEF DESCRIPTION OF THE DRAWINGS

Implementations of the present disclosure will now be described, by way of example only, with reference to the attached FIGURES.

FIG. 1 is a diagram of a stationary light source in accordance with an embodiment of the present disclosure.

### DETAILED DESCRIPTION

It will be appreciated that for simplicity and clarity of illustration, where appropriate, reference numerals have been repeated among the different FIGURES to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

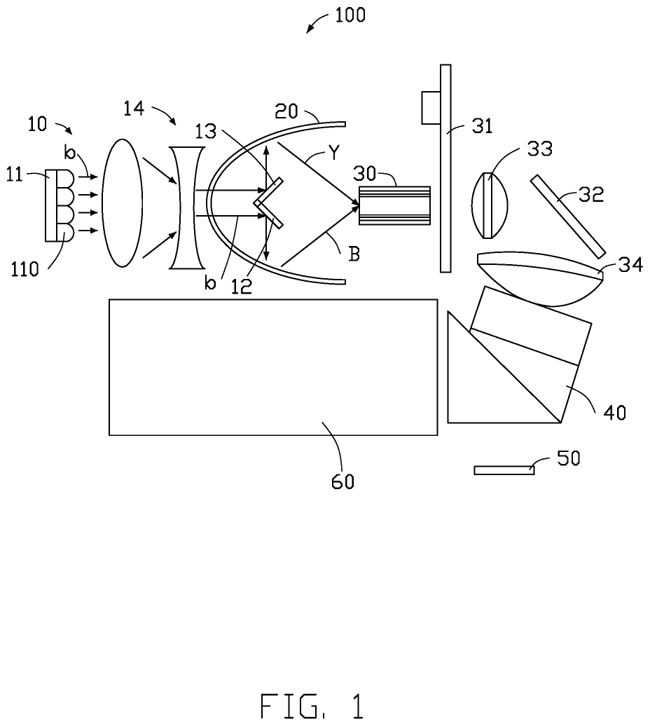

FIG. 1 shows an embodiment of a stationary light source 100. The stationary light source 100 includes a light source group 10, a light combining device 20, a light guide assembly 30, a mirror group 40, a digital micro-mirror device 50, and a projection lens set 60. The light source group 10 primarily generates two-colored light having high light intensity. The two-colored light is evenly split after passing through the light combining device 20 and then combined into a combined light beam by the light combining device 20 and projected onto the light guide assembly 30 to eliminate light spots. The light guide assembly 30 is a light tunnel. The combined light beam passing through the light guide assembly 30 is passed through a color wheel 31 and a reflecting mirror 32, and then projected to a mirror group 40. A lens 33 is located between the color wheel 31 and the reflecting mirror 32, and a lens 34 is located between the reflecting mirror 32 and the mirror group 40. The lenses 33, 34 focus the combined light beam. The mirror group 40 is a reverse total internal reflection (RTIR) mirror group composed of two mirror groups. The combined light beam is passed through the mirror group 40 and projected to the digital micro-mirror device 50. The digital micro-mirror device 50 forms an image beam after receiving the combined light beam. The image beam is passed through the mirror group 40 and then reverse reflected to the projection lens set 60 so that the image beam formed by the digital micro-mirror display 50 is projected out.

The light source group 10 includes a laser source 11, a scattering mirror 12, and a fluorescent scattering mirror 13. The laser source 11 includes at least one laser generator 110 for generating a laser beam b. The scattering mirror 12 and the fluorescent scattering mirror 13 are located within the light combining device 20. In one embodiment, the laser source 11 includes four laser generators 110 for generating high-intensity laser beams b. The laser beam b generated by the laser source 11 is split into two beams, one beam projected to the scattering mirror 12 and generating a first colored light, and a second beam projected to the fluorescent scattering mirror 13 and generating a second colored light.

A lens group 14 is located at a front end of the laser source 11. The lens group 14 includes concave and convex lenses. The lens group 14 focuses the laser beam b emitted by the laser source 11. In one embodiment, the laser beam b is blue, the first colored light is blue light B, and the second colored light is yellow light Y.

An optical path of the first colored light is scattered by the scattering mirror 12 located in front of the light combining device 20 to guide the light combining device 20 after passing through the light combining device 20 located at a front end of the laser source 11.

A surface of the fluorescent scattering mirror 13 receiving light comprises an illumination zone configured to receive illumination from the laser beam b. In one embodiment, the illumination zone includes a fluorescent layer. The fluorescent scattering mirror 13 may be a glass panel infused with fluorescent powder, or may be made of fluorescent-infused crystal. The fluorescent layer illuminated by the laser beam b is excited to generate the second colored light Y. A light path of the second colored light Y is reflected by the light combining device 20 to guide the light guide assembly 30 after being reflected by an illumination surface of the fluorescent scattering mirror 13 to the light combining device 20.

The light combining device 20 is a semielliptical hollow reflecting mirror. The scattering mirror 12 and the fluorescent scattering mirror 13 are adjacent to a focal point of the light combining device 20. The light combining device 20 receives the blue light B scattered by the scattering light 12 and the yellow light Y generated by the fluorescent scattering mirror 13. The light combining device 20 combines and focuses the light to form a combined light beam and projects the combined light beam to the light guide assembly 30.

The combined light beam formed from the blue light B and the yellow light Y has an enhanced brightness. Because the two colors of light (blue, yellow) generated by the light source group 10 have the high-intensity characteristics of the laser source 11, brightness of projection images of the projector is increased, and a color temperature of the projection images can be adjusted by adjusting a ratio of the laser beams b projected to the scattering mirror 12 and the fluorescent scattering mirror 13, thereby increasing portability of the projector.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A stationary light source comprising:
a light source group comprising a laser source, a scattering mirror, and a fluorescent scattering mirror, a laser beam generated by the laser source comprising a first beam shining onto the scattering mirror to generate a first colored light, and a second beam shining onto the fluorescent scattering mirror to generate a second colored light;
a light guide assembly; and
a light combining device configured to combine and concentrate the first colored light and the second colored light and emit the combined and concentrated light onto the light guide assembly; wherein:
the light combining device is a semielliptical hollow reflecting mirror; and
the scattering mirror and the fluorescent scattering mirror are located within the light combining device.

2. The stationary light source of claim 1, wherein:
the laser beam is blue;
the first colored light is blue; and
the second colored light is yellow.

3. The stationary light source of claim 1, wherein the first colored light is scattered by the scattering mirror located within the light combining device to guide the light to an inner side of the light combining device after passing through a portion of the light combining device located at a front end of the laser source.

4. The stationary light source of claim 1, wherein a lens group is located at a front end of the laser source, the lens group configured to concentrate the laser beam emitted by the laser source.

5. The stationary light source of claim 1, wherein the laser source comprises at least one laser generator for generating the laser beam.

6. The stationary light source of claim 1, wherein a surface of the fluorescent scattering mirror receiving light comprises an illumination zone configured to receive illumination from the laser beam.

7. The stationary light source of claim 6, wherein the illumination zone comprises a fluorescent layer; the fluorescent layer illuminated by the laser source is excited to generate the second colored light.

8. The stationary light source of claim 6, wherein the fluorescent scattering mirror is a glass panel infused with fluorescent powder.

9. The stationary light source of claim 6, wherein the fluorescent scattering mirror is made of fluorescent-infused crystal.

10. The stationary light source of claim 1, wherein the second colored light is reflected by the light combining device to be guided to the light guide assembly after being scattered by an illumination surface of the fluorescent scattering mirror to the light combining device.

11. The stationary light source of claim 1, wherein the scattering mirror and the fluorescent scattering mirror are adjacent to a focal point of the light combining device.

12. A stationary light source comprising:
a light source group configured to emit a first colored light;
a scattering mirror configured to reflect a first portion of the light emitted by the light source group;
a fluorescent scattering mirror configured to reflect a second portion of the light emitted by the light source group;
a lens group configured to focus and project the light emitted by the light source group to the scattering mirror and the fluorescent scattering mirror;
a light combining device configured to combine the first portion of the light and the second portion of the light into a combined light beam and focus the combined light beam to a light guide assembly; wherein:
the second portion of the light reflected by the fluorescent scattering mirror is a second colored light different from the first colored light.

13. The stationary light source of claim 12, wherein:
the lens group projects the light to the scattering mirror and the fluorescent scattering mirror through the light combining device; and
the scattering mirror and the fluorescent scattering mirror are located adjacent a focal point of the light combining device.
